(19) United States
(12) Patent Application Publication
(10) Pub. No.: US 2009/0295361 A1
(43) Pub. Date: Dec. 3, 2009

(54) Apparatus For Converting Electrical Energy For Conductively Heating Semiconductor Material In Rod Form

(75) Inventors: Norbert Ellinger, Postmuenster (DE); Josef Auer, Hochburg (AT); Paul Fuchs, Schalchen (AT); Elmar Monz, Marktl (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/471,562

(22) Filed: May 26, 2009

(30) Foreign Application Priority Data
Jun. 3, 2008 (DE) 10 2008 002 184.9

(51) Int. Cl. H02J 3/00

(52) U.S. Cl. 323/318

(57) ABSTRACT

The present invention relates to an apparatus for converting electrical energy for conductively heating rod-shaped semiconductor materials. The apparatus is particularly useful to control the temperature of electrically heated rods in the Siemens process for deposition of silicon by chemical vapor deposition.

### CROSS-REFERENCE TO RELATED APPLICATIONS

This application claims priority to German application DE 10 2008 002 184.9 filed Jun. 3, 2008, which is herein incorporated by reference.

### BACKGROUND OF THE INVENTION

1. Field of the Invention

The invention relates to an apparatus for converting electrical energy for conductively heating rod-shaped semiconductor materials in a gas flow, referred to as a “compact power supply” hereinafter.

2. Background Art

Compact power supplies are widespread both in industry and in trade. In this case, transformer, regulating technology, rectifier and other components are arranged in such a way that there is a minimal space requirement and connections are made as short as possible.

Compact power supplies are used for power supply purposes for example in switching technology, for computer systems and machine or industrial controllers in the DC and AC voltage ranges. Compact power supplies are used both in the single-digit watt range and in the megawatt range in industrial installations.

Compact power supplies are particularly suitable in the conversion of electrical energy for conductively heating polysilicon in rod form. One of these processes is generally termed the “Siemens process,” where silicon is deposited by chemical vapor deposition at high temperature onto an electrically heated carrier rod of silicon.

The resistivity of semiconductor materials has a greatly decreasing temperature coefficient. The problem thus arises that the power supply has to supply a high output voltage (volts) for cold heater material and a high current intensity (amperes) for hot heater material (FIG. 2).

The current/voltage characteristic curve can be seen to be linear by way of example. This usually involves heating applications with high heating energy of a few 100 kW to a number of megawatts. Owing to the high power, economic operation is possible only at high efficiencies of greater than 97%. What is problematic at these high powers is the effect of the so-called reaction on the system if the operation of an electrical load influences the stability and form of the voltage supply system.

In order to minimize reactions on the system, a low current harmonic content and low displacement reactive power should be striven for at such high powers. Furthermore, the heating energy must be drawn in a balanced manner in 3-phase fashion from the feeding system in order to prevent single-phase system distortions. In this case, the primary system supply voltage is largely insignificant and usually lies between 3 kV and 400 kV.

A further particular feature when heating semiconductor materials in a cooling gas flow is the fast and great change in resistance with temperature. This property demands fast power regulation of the heating energy without, or with only very short, energyless intermissions. A mechanically optimized construction of a compact power supply is furthermore of considerable importance for economically arranging the high-current components.

In industry, the problems mentioned above have been solved by means of energy converting apparatuses comprising a transformer with independent power controllers per voltage tap of the transformer.

The utility model DE 202005010333 U1 describes a single-phase circuit arrangement which additionally requires an auxiliary switch “S”, which makes it possible to use controllable switching means (e.g. thyristors) with in part reduced dielectric strength (see switching means 20, 21 in that document). This publication describes a circuit arrangement (4) and transformer (T) that are connected to one another. However, the spatial arrangement of the overall installation is not discussed. The combination of the electrical and mechanical properties is likewise not mentioned.

What is disadvantageous about this arrangement is that an additional switching arrangement “S” is required, which could be dispensed with given the use of switching elements (semiconductor components of all types) having sufficient dielectric strength. This would considerably simplify the circuit and hence the construction.

The utility model DE 202004004655 U1 likewise describes a single-phase circuit arrangement for supplying greatly variable loads. This also involves a single-phase transformer/controller combination. The circuit apparatus discloses the possibility of two greatly variable loads being connected, first in parallel, and then in series connection. The structural embodiment and the electrical properties are not discussed here either. What is disadvantageous about this circuit arrangement is that by virtue of the parallel/series changeover, an energyless intermission (>20 ms) arises at the instant of changeover at the load, this intermission being undesired.

The arrangements described in the prior art are all single-phase. The additional circuitry outlay for constructing them in a three-phase embodiment is considerable and uneconomical.

### SUMMARY OF THE INVENTION

Therefore, the object was to provide a polyphase circuit arrangement which does not have the disadvantages demonstrated in the prior art.

### BRIEF DESCRIPTION OF THE DRAWINGS

FIG. 1 illustrates on embodiment of the three-phase power converter of the subject invention.

FIG. 2 illustrates a voltage/current relationship achievable by the converter of FIG. 1.

### DETAILED DESCRIPTION OF THE PREFERRED EMBODIMENT(S)

The invention relates to a three-phase converter arrangement for converting electrical energy with impressed system voltage into a process-dependent variable electrical energy for conductively heating rod-shaped semiconductor materials, comprising:

(A) a three-phase primary winding, which is connected to the supply system, and

(B) three secondary windings, wherein each of the three secondary windings of the installation transformer has more than two voltage taps with a power controller connected downstream, which are electrically connected on the side remote from the transformer directly, without a further switching element, and

(C) three heating circuits comprising the secondary windings and the heated semiconductor materials, which are connected up in star connection for the separate regulation of the heating energies by means of the load resistances, wherein the power components of the controllers are locally arranged, directly at the three-phase transformer, in order to optimize volume.

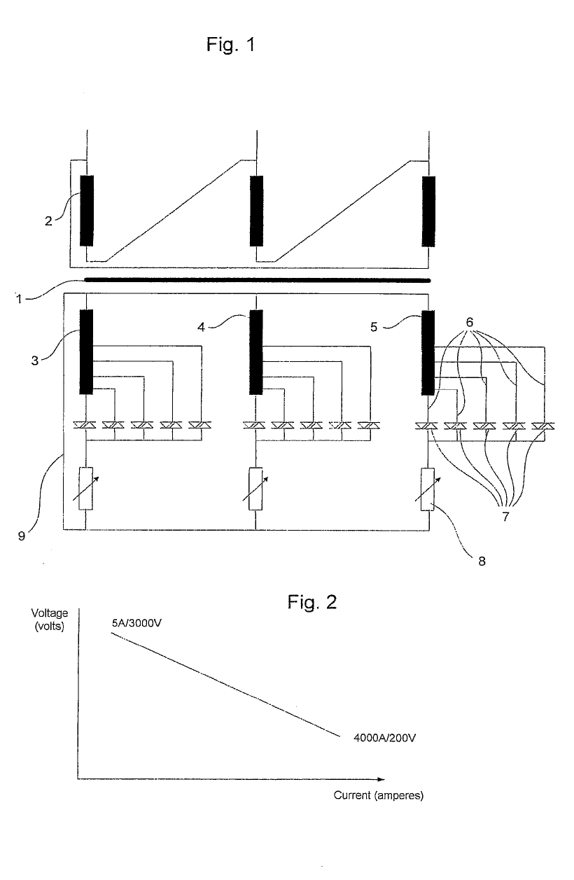

The three-phase primary winding of the three-phase installation transformer is connected to the supply system. The terminal voltage is usually 3 kV to 400 kV, preferably 3×10 kV. The operation may be illustrated by reference to FIGS. 1 and 2.

Each of the three secondary windings (3, 4, 5) of the transformer has more than two voltage taps. Three to 10 taps are preferred, and 4 to 6 are particularly preferred. The position of the taps on the secondary windings is in each case defined in a manner optimized with regard to reactions on the system for the respective application, taking account of the desired current/voltage characteristic curve (FIG. 2).

Each voltage tap on the secondary windings has a power controller (7) connected downstream. The number of power controllers per phase corresponds to the number of voltage taps. The power controllers essentially comprise back-to-back standard power thyristors with driving electronics. However, other switching power semiconductors such as thyristors or transistors of all types are also conceivable. The voltage taps are preferably directly electrically connected to the power controllers on the side remote from the transformer, without a further switching element.

The triggering angles of the power controllers can be predetermined separately from one another and perform the continuously required voltage control for the heating of the semiconductor rods (8). The regulating electronics for driving the power semiconductors can be arranged within or alternatively, for better accessibility, outside the high-energy region. This circuit arrangement (multiply superposed controller output voltage through the transformer taps) ensures a high power factor (active power/apparent power) of between 0.87-1.

The heating energy per rod-shaped semiconductor can be provided virtually continuously by means of the arrangement according to the invention. The maximum gap here is the duration of a sinusoidal half-cycle. The star point connection (9) ensures that the current through the three load resistances can be regulated separately from one another.

In a preferred embodiment, the three heating circuits comprising the secondary windings and the heated semiconductor materials can also be embodied, instead of with the star point connection described, in potential-isolated fashion with three individual current feedbacks (one per phase). The communication between the regulating electronics and the power section can be effected by means of optical or non-optical data connections.

A highly space-saving apparatus for converting electrical energy for conductively heating semiconductor material is obtained on the basis of the circuit arrangement according to the invention. In the production and operation of such circuit arrangements this results in a saving of space and of costs by comparison with known installations such as are currently used in industry. With the arrangement according to the invention, for the first time it has become possible to construct conversion apparatuses having a spatial volume of <13 m³ in the load and control range described.

The invention will be explained in more detail on the basis of the following example.

### EXAMPLE 1

A three-phase circuit arrangement was constructed analogously to FIG. 1, the three primary windings (2) of which circuit arrangement were connected to the supply system. The three secondary windings (3, 4, 5) were each embodied with five voltage taps (6). Each of these voltage taps on the secondary windings has a power controller (7) connected downstream. The power controllers comprise back-to-back standard power thyristors with driving electronics.

The installation has a regulable output power range of 0 to 5 MVA. The three-phase arrangement causes balanced reactions on the system in the case of a balanced load.

The enclosed volume of the three-phase converter installation is approximately 13 m³. The nominal efficiency is >97%. When the installation is in operation, there is a continuous energy input into the semiconductor material.

The maximum output current range is 3×0-4000 A, each phase being separately regulable. The maximum output voltage range (Ua) is 3×50-3000 V.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A three-phase converter arrangement for converting electrical energy with impressed system voltage into a process-dependent variable electrical energy for conductively heating rod-shaped semiconductor materials, comprising:
(A) a three-phase primary winding, which is connected to the supply system, and
(B) three secondary windings, wherein each of the three secondary windings of the installation transformer has more than two voltage taps with a power controller connected downstream, and
(C) three heating circuits comprising the secondary windings and the heated semiconductor materials, which are connected in star connection for the separate regulation of the heating energies by means of the load resistances, wherein the power components of the controllers are locally arranged directly at the three-phase transformer.

2. The method of claim 1, wherein the position of the taps on the secondary windings is defined with regard to reactions on the system for the respective application, defined by a target current/voltage characteristic curve.

3. The method of claim 1, wherein the power controllers comprise back-to-back power thyristors with driving electronics.

4. The method of claim 2, wherein the power controllers comprise back-to-back power thyristors with driving electronics.

5. The method of claim 1, wherein the voltage taps are directly connected to the power controllers on the side remote from the transformer, without a further switching element.

6. The method of claim 3, wherein the voltage taps are directly connected to the power controllers on the side remote from the transformer, without a further switching element.

7. The method of claim 1, wherein the triggering angles of the power controllers are predetermined separately from one another and the latter continuously control voltage for heating semiconductor carrier rods.

8. The method of claim 1, wherein the regulating electronics for driving the power semiconductors are arranged outside a high-energy region of the converter.

9. The method of claim 1, wherein the heating energy per rod-shaped semiconductor is provided continuously.

10. The method of claim 1, wherein the three-phase converter has an enclosed volume of <13 m³.

11. A three-phase converter arrangement for converting electrical energy with impressed system voltage into a process-dependent variable electrical energy for conductively heating rod-shaped semiconductor materials, comprising:
(A) a three-phase primary winding, which is connected to the supply system, and
(B) three secondary windings, wherein each of the three secondary windings of the installation transformer has more than two voltage taps with a power controller connected downstream, and
(C) three heating circuits comprising the secondary windings and the heated semiconductor materials, which are connected in potential-isolated fashion with a separate individual current feedback per phase, for the separate regulation of the heating energies by means of the load resistances, wherein the power components of the controllers are locally arranged directly at the three-phase transformer.

12. In a process for the production of silicon by chemical vapor deposition of silicon onto electrically heated carrier rods of silicon, the improvement comprising heating the carrier rods by means of the three-phase converter of claim 1.
